(19) United States
(12) Patent Application Publication
(10) Pub. No.: US 2024/0123836 A1
(43) Pub. Date: Apr. 18, 2024

(54) Capacitor power bank system with charging function of electric vehicle

(71) Applicant: Planet Love Co., LTD., Gimhae-si (KR)

(72) Inventor: Eui Suk KANG, Changwon-si (KR)

(21) Appl. No.: 17/986,690

(22) Filed: Nov. 14, 2022

(30) Foreign Application Priority Data
Oct. 13, 2022 (KR) 10-2022-0131632

(51) Int. Cl. B60L 15/20; B60L 3/00; B60L 3/12; B60L 7/12; B60L 50/52; H02J 7/00; H02J 7/34; H02P 23/00; H02P 25/03; H02P 27/06; H02P 29/024

(52) U.S. Cl. CPC B60L 15/2009; B60L 3/003; B60L 3/0061; B60L 3/12; B60L 7/12; B60L 50/52; H02J 7/0029; H02J 7/0063; H02J 7/345; H02P 23/0004; H02P 25/03; H02P 27/06; H02P 29/0241; B60L 2210/10; B60L 2220/12; B60L 2220/16; B60L 2240/421; H02J 2207/20; H02J 2207/50

(57) ABSTRACT

A power bank system may include a motor control driver configured to receive a first power from a capacitor power bank and supply the power to an electric vehicle for operating and supply a second power generated through regenerative braking to a capacitor module when a brake is operated, a motor drive control inverter that controls a rotation of a motor, the capacitor power bank performs a charging and a protection function of the capacitor module when an abnormality of the motor and manages abnormalities in a cell in the capacitor module, a charging controller for charging the capacitor module, a first sensor for detecting an over voltage and over current, a second sensor for detecting a reverse current, a central controller for controlling the motor drive controller invertor, and a dashboard connected to a the central controller for providing the driver with an abnormality of the power bank.

### FIELD OF TECHNOLOGY

The present invention relates to charge/discharge system using a capacitor, and more specifically, a capacitor power bank system having a charging function of an electric vehicle capable of rapid charging as well as stable discharge control for electric vehicles such as electric golf carts that operate a lot of regenerative braking sections.

### BACKGROUND TECHNOLOGY

Until now, in the method of storing electricity generated by regenerative braking in a secondary battery, some of the electricity generated by regenerative braking is stored in a secondary battery, and the surplus electricity that cannot be charged is treated as heat through a resistor, and the electricity produced with difficulty is often consumed as resistance loss.

It refers to the electrical energy generated by the armature of the motor while braking the electric vehicle to drive faster than a constant speed at the moment of applying the brake or on a downhill road. In order to store the electrical energy generated in this way, it has been used as a method of storing energy in electricity in the secondary battery, but due to the characteristics of the secondary battery, electricity is stored for chemical production, so it must be reduced very quickly in order to store the electricity generated during braking. Therefore, the storage capacity of energy generated by regenerative braking of secondary batteries is quite low.

In addition, when the secondary battery is fully charged, the electricity generated by regenerative braking is not charged with the secondary battery, but a transient voltage may occur in the control device of the electric train due to a transient phenomenon, which may cause problems in the operating device. In addition, overheating may occur in the secondary battery, resulting in burnout or shortened life.

Surplus electricity that cannot be processed by the regenerative control resistor consumes residual electricity by a regenerative resistance to escape through a bypass path, but the remaining electric or surplus electricity may increase the braking distance or cause damage to the drive motor control circuit.

Furthermore, if the braking distance is sufficient on the downhill road, the battery is charged with electricity generated by the braking, the excess electricity is wasted by the heating of the regenerative resistor, conversely, when climbing a slope, the energy of the secondary battery is used, so the effect of regenerative braking is not greatly affected.

In addition, if the electric vehicle is used during a daytime and then used at night, it will be charged at an electric charging station using commercial electricity for several hours at a charging station during a daytime. In the case of collective charging in this way, due to the increase in a peak power, a customer receives the power for energy storage of the electric vehicle from KEPCO, which is a main cause of the increase in a basic charge.

Meanwhile, a regenerative braking system for fuel cell vehicles using supercapacitors in Korean Patent Publication No. 10-2008-0044097 (2008.05.20) has been proposed.

However, the above technology only uses supercapacitors and lacks a control system function according to charging and discharging between the supercapacitor and the fuel cell due to regenerative braking.

### [Invention Disclosures]

### Problems to be Solved

An object according to an aspect of the present invention, which was devised to solve the above problems, is to quickly and stably charge and discharge electricity according to regenerative braking. By implementing a capacitor control system capable of discharge, a capacitor power bank having the ability to quickly charge and control stable discharge for electric vehicles such as electric golf carts that operate in the regenerative braking section system.

### Means for Solving Problems

According to an embodiment of the present invention for achieving the above object, a capacitor power bank system having a charging function of an electric vehicle, a motor controlling driver 100 configured to receive a first power from a capacitor power bank 300 and supply the first power to the electric vehicle for operating and supply a second power generated through regenerative braking to a capacitor module 310 of the capacitor power bank 300 when a brake is operated, a motor drive control inverter 200 that adjusts and controls a frequency according to a rotation of a motor and drives the motor at a predetermined revolutions per minute (RPM), a capacitor power bank 300 having a capacitor charging power system (COPS) 320 that performs a charging, a discharging, and a protection function of the capacitor module 310 when an abnormality of the motor or the motor drive control inverter occurs during power supply to the motor drive driver 100, and manages the presence or absence of abnormalities in a cell in the capacitor module 310, a charging controller 410 for charging controlling the capacitor module, a first sensor for detecting an over voltage and over current, a second sensor for detecting a reverse current, a central controller 400 for controlling the motor drive controller invertor 200 and the COPS 320, a dashboard 500 connected to a the central controller 400, having a communication and monitor 510 for that provides the driver with a charge and discharge state, a supply voltage state, and an abnormality in voltage and temperature for each cell of the power bank 300.

According to another embodiment of the present invention, the motor drive control inverter 200 may adjust and control a frequency of a brushless direct current motor (BLDC) motor or an induction motor of the motor drive driver 100.

According to another embodiment of the present invention, when a forward current is detected from the first sensor 420, the motor driving control inverter 200 may receive a command from the central controller 400 to adjust and control a frequency, and then drive the motor driving driver 100 for controlling the motor.

According to another embodiment of the present invention, the motor drive control inverter 200 is supplied with a Proportional-Integral-Differential Controller (PID) signal for adjusting a frequency of the motor with a voltage generated by a resistance connected to the driver's excel pedal to rotating at a predetermined revolution per minute (RPM) by a supplied voltage or a current.

According to another embodiment of the present invention, the capacitor power bank 300 may be manufactured using one or two to three banks, and configured in series, parallel, or series-parallel so that it can be operated 1 to N times when used in electric vehicles, and then replaced easily through a connector and/or a connection jack.

According to another embodiment of the present invention, the capacitor power bank 300 may include a DC/DC converter 330, which supports a discharge function during rapid charging and large current drive, it can be used as an alternative power for an electric vehicle using a secondary battery such as a lead acid battery, a ternary battery, a lithium iron phosphate battery, and a lithium-ion polymer battery.

According to another embodiment of the present invention, the capacitor charging power system 320 may charge by maintaining a balance of the cell in the capacitor module 310 according to a command of the central controller 400.

According to another embodiment of the present invention, if the COPS 320 sense a reverse current by regenerative braking through the second sensor 430 in the motor driving driver 100, in this case, the CCP may measure the voltage of the capacitor power bank 300 and then determine whether to charge and open the circuit or if an overvoltage occurs, an overvoltage protection circuit 321 having a cut off circuit that cuts off a voltage supplied to the power bank is further provided.

According to another embodiment of the present invention, to protect the motor controlling driver 100 and a user, i.e., a passenger, when a transient current of the motor is detected through the motor drive driver 100 sensed by the first sensor 420, the central controller 400 may control a gate voltage of the motor drive control inverter 200 by controlling an electronic relay, a gate voltage of Insulated Gate Bipolar Transistor (IGBT), a gate voltage of the Field Effect Transistor (FET), or a base voltage of the Transistor (TR) embedded in the capacitor module 310 to stop or constant speed drive the motor through the motor driving control inverter 200.

According to another embodiment of the present invention, a count electromotive force by regenerative braking by the motor controlling driver 100 and when a reverse current is detected by the second sensor 430, the central controller 400 may control, for example, a gate voltage of an Insulated Gate Bipolar Transistor (IGBT), a gate voltage of a Field Effect Transistor (FET), or a base voltage of Transistor (TR) embedded in the COPS 320 in the capacitor power bank 300 to charge in each cell in the capacitor module 310, thereby charging the capacitor power bank 300.

According to another embodiment of the present invention, the central controller 400 may issue a command to the CCS 320 when a full charging voltage arrives power bank 300 to block a charging voltage from being supplied to the capacitor module 310 of the capacitor power bank 300.

According to another embodiment of the present invention, the communication and monitor 510 may include a Bluetooth or Controller Area Network (CAN) to provide the driver with a charging and discharging state and a voltage state of the capacitor module 310, and the presence or absence of abnormal voltage and temperature of the cell.

According to another embodiment of the present invention, the communication and monitoring function may be performed through a universal asynchronous receiver transmitter (UART), and may monitor a voltage and a current balance, a temperature abnormality, and an abnormal charge, and discharge state of the cell of the capacitor power bank 300.

### Effects of the Invention

The capacitor power bank system having a charging function for an electric vehicle has the following effects according to an embodiment of the present invention.

(1) By using a capacitor as the regenerative braking generation energy storage device, it is possible to have the same performance even with less power compared to the operating capacity of the secondary battery, such as an electric golf cart that has many operations in the regenerative braking section, fast charging and stable discharge control are possible.

The central controller may control the capacitor power bank through the instructions issued to the capacitor charging power system (COPS) and control an RPM of the motor and a reverse current of the motor drive driver through frequency adjustment of the motor drive control inverter, enabling more efficient control of the capacitor power bank.

### BRIEF DESCRIPTIONS OF DRAWINGS

FIG. 1 illustrates a conventional art.

FIG. 2 is a block diagram illustrating the entire technical configuration of a capacitor power bank system having a charging function of an electric vehicle according to an embodiment of the present invention.

FIG. 2 is a block diagram illustrating the entire technical configuration of a capacitor power bank system having a charging function of an electric vehicle according to an embodiment of the present invention.

FIG. 3 is a diagram showing a protection circuit of a capacitor power bank for a capacitor power bank system having a charging function of an electric vehicle according to an embodiment of the present invention.

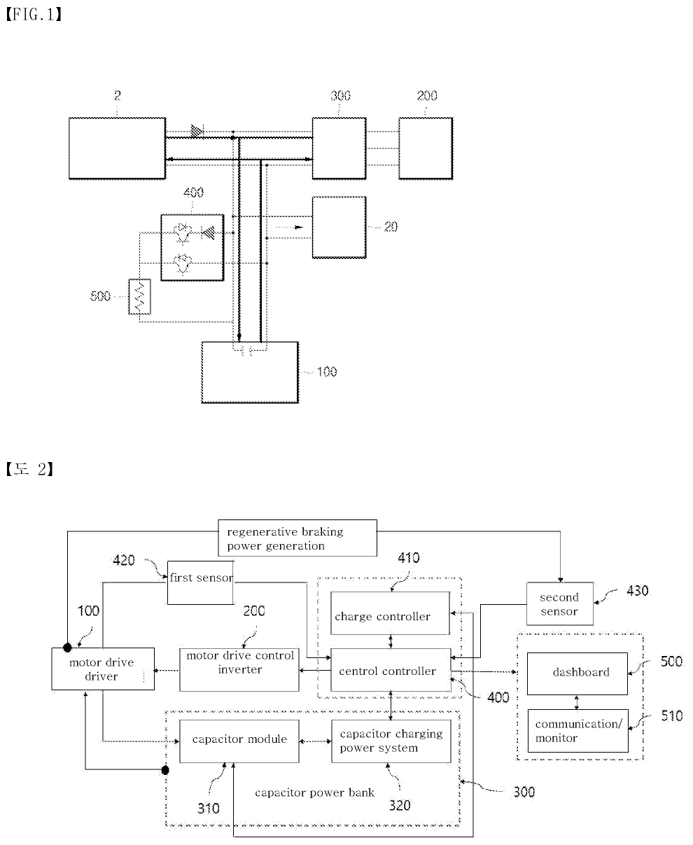

### DETAILED EMBODIMENTS

Various embodiments of the present invention will now be described in detail with reference to the annexed drawings. In the following description, a detailed description of known functions and configurations incorporated herein has been omitted for clarity and conciseness. Terms used herein are defined based on functions in the present invention and may vary according to users, operator intention, or usual practices. Therefore, the definition of the terms should be made based on contents throughout the specification. In addition, in describing the present invention, when it is determined that a detailed description of a related known configuration or function may obscure the gist of the present invention, the detailed description thereof will be omitted.

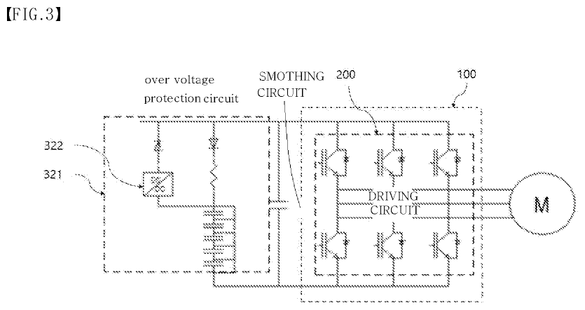

Referring to FIGS. 2 to 3, a capacitor power bank system with charging function of electric vehicle according to the present invention may include a motor control driver 100, a motor drive control inverter 200, a capacitor power bank 300, a central controller 400, and a dashboard 500.

Referring to FIGS. 2 and 3, the motor controlling driver 100 is for driving an electric vehicle, and supplying power generated through regenerative braking when the brake is operated to the capacitor module 310 of the power bank 300.

Referring to FIGS. 2 and 3, the motor drive control inverter 200 may adjust a frequency of the motor controlling driver 100 for adjusting an RPM of a motor, for example, an induction motor or a BLDC motor, according to an aspect of the present invention.

Here, the reason why the motor is driven at a predetermined RPM through the motor drive control inverter 200 is to protect the motor and enhance a safe operation of the electric vehicle from overspeeding.

In addition, according to another embodiment of the present invention, the motor drive control inverter 200 may adjust and control the frequency of the brushless direct current motor (BLDC) motor or an induction motor connected to the motor controlling driver 100.

In addition, according to another embodiment of the present invention, when a forward current is detected from the first sensor 420, the motor drive control inverter 200 may receive a command from the central controller 400 to adjust and control the frequency, and then drive the motor connected to the motor controlling driver 100.

The motor driver 100 is implemented to drive the motor connected to the motor driver 100 only when a forward current is detected by the first sensor 420, unlike driving the motor, when a reverse current detected by the second sensor 430 is sensed, it is intended to perform a charging function by a count electromotive force according to a regenerative braking.

In addition, according to another embodiment of the present invention, In the motor drive control inverter 200, a Proportional-Integral-Differential controller (RD) signal that adjusts and controls the frequency of the motor with a voltage generated according to a resistor connected to the driver's accelerator pedal is transmitted to the motor drive control inverter 200 is supplied, and driving is controlled so that the driving is performed at a predetermined RPM determined as a frequency constant by a supplied voltage or current.

Referring to FIG. 2, the capacitor power bank 300 is a device to supply power to the motor controlling driver 100 by which connected plurality of capacitors in series or in parallel to enable charging and discharging.

The capacitor power bank 300 may include capacitor module 310, when an abnormality of the motor or inverter occurs during power supply to the motor controlling driver 100, the capacitor module 310 may perform a charging, discharging, and protection function, and manage the abnormality of the cell in the capacitor module 310.

Here, the capacitor power bank 300 can not only have the same performance with less power than the operating capacity of the conventional secondary battery, but also quickly charge electric vehicles such as electric golf carts that operate a lot in the regenerative braking section, as well as stable discharge control by a central controller 400.

In addition, according to another embodiment of the present invention, the capacitor charging power apparatus COPS 320 may maintain the balance of the cell in the capacitor module 310 according to an instruction of the central controller 400 to perform charging.

Here, the implementation of the COPS 320 to receive commands from the central controller 400 is for maintaining the central controller 400 controlling over the entire capacitor power bank system having a charging function of an electric vehicle according to an embodiment of the present invention, thereby simplifying the configuration of the system to reduce cost and secure reliability of the system.

In the COPS 320, when a reverse current is detected through the second sensor 430 by regenerative braking in the motor driving driver 100, the COPS may further include an overvoltage protection circuit having a cut off circuit for determining whether to charge after measuring the voltage of the capacitor power bank 300 to short circuit the circuit or to cut off the voltage when a transient voltage occurs, i.e., an overvoltage.

In addition, according to another embodiment of the present invention, the capacitor power bank 300 is manufactured in one or 2 to 3 banks, and when used in an electric vehicle, after being configured with in a serial, parallel, or serial parallel, they can be configured for easy replacement through connectors and connection jacks.

Here, the capacitor power bank 300 is configured to be easily replaced through the connector and the connection jack to save time according to charging in the case of an electric golf cart and to prevent interference with playing golf.

In addition, according to another embodiment of the present invention, the capacitor power bank 300 has a built-in DC/DC converter 330 that supports a quick charge and a rapid charging function during high current driving, with a smaller capacity than secondary batteries, it can be used as an alternative power for electric vehicles using secondary batteries such as lead acid batteries, ternary batteries, lithium iron phosphate batteries, and lithium-ion polymer batteries.

Referring to FIG. 2, the central controller 400 is a device for controlling a capacitor power bank system having a charging function of an electric vehicle according to an embodiment of the present invention.

The central controller 400 may control a charge controller 410 for controlling the charging of the capacitor module 310 and a first sensor 420 for detecting an overvoltage of the motor controlling driver 100, a second sensor 430 for detecting a reverse current of the motor controlling driver 100, a motor drive control inverter 200, and the COPS 320.

Here, the first sensor 420 may sense an overvoltage of a motor through a controlling driver 100, and the second sensor 430 may sense the reverse current of the motor controlling driver 100 inputted from the motor, respectively.

In addition, according to another embodiment of the present invention, the central controller 400, when a transient current, i.e., an over-current, is detected in the motor of the motor controlling driver 100 from the first sensor 420, to protect a user and/or the motor control driver 100, may control an electronic relay, an Insulated Gate Bipolar Transistor (IGBT), a gate voltage of a Field Effect Transistor (FET), or a base voltage of a Transistor (TR) in the capacitor module 310, and thus, the motor connected to the motor drive driver 100 is controlled through the motor driving control inverter 200, thereby the motor can be safely stopped or controlled to enable a constant speed driving.

In addition, according to another embodiment of the present invention, when a reverse electromotive force is generated by regenerative braking by the motor control driver 100 and a reverse current is detected by the second sensor 430, the central controller 400 may output a signal to the COPS 320 of the capacitor power bank 300, for example, a gate voltage of an Insulated Gate Bipolar Transistor (IGBT), a gate voltage of a Field Effect Transistor (FET), or a base voltage of Transistor (TR) embedded in the COPS 320 in the capacitor power bank 300 is turned on to charge in each cell in the capacitor module 310, thereby charging the capacitor power bank 300 with generated energy.

Here, using various electronic devices embedded in the capacitor module 310, the motor controlling driver 100, the central controller 400 may easily charge each cell in the capacitor module 310 through a counter electromotive force generated in a regenerative braking section,

That is, the central controller 400 may control, for example, a gate voltage of an electronic relay, the IGBT, or the FET or a base voltage of the TR for enabling charging with energy generated.

In addition, according to another embodiment of the present invention, when the power bank 300 is a full charged, the central controller 400 may issue a command to the COPS 320 to block the charging voltage from being supplied to the capacitor module 310 of the capacitor power bank 300.

Here, through a command between the central controller 400 and the COPS 320 according to an embodiment of the present invention, the capacitor module 310 of the capacitor power bank 300 can be protected from overcharging.

Referring to FIG. 2, the dashboard 500 is connected to the central controller 400 as a device for monitoring a capacitor power bank system having a charging function of an electric vehicle according to an embodiment of the present invention, and a communication and monitor 510 that provides a charging and/or a discharging state of the power bank 300, a supply voltage state of the power bank 300, and an abnormality in voltage and temperature for each cell.

In addition, according to another embodiment of the present invention, the communication and monitor 510 may be configured to enable Bluetooth or controller area network (CAN) communication to provide a user with a state of charging and discharging, a state of voltage, and a temperature abnormality of the capacitor module 310.

Here, the CAN communication is a standard communication standard designed for electronic control units (ECUs) to communicate with each other without a host computer in a vehicle, and is a non-host bus-based message-based network mainly used for communication between each controller.

Since the CAN is developed to reduce cable wiring, only a pair of wires may be communicated inside the electric vehicle according to an embodiment of the present invention, and thus anyone may safely drive a vehicle such as an electric golf car.

In addition, according to another embodiment of the present invention, the communication and monitoring function through the communication and monitor 510 is performed through a universal asynchronous receiver transmitter (UART), and the function abnormality of the voltage and current balance of the capacitor power bank 300, the temperature abnormality, and the abnormal charging and discharging state of the cell of the capacitor power bank 300 are monitored.

Here, the UART is a program that processes asynchronous serial communication of a computer, usually realized as a microchip, and provides an RS-232C DTE interface to communicate or exchange data with a modem or other serial device. The UART also converts or restores parallel data into serial bit streams, adds parity bits, detects and removes parity, and adds and deletes start and stop bits for asynchronous communication.

Therefore, in the embodiment of the present invention, the communication and monitoring functions are performed through the dashboard 500 in consideration of the characteristics of the UART, thereby providing convenience for the driver of the electric vehicle.

Although this application is described with reference to specific features and the embodiments thereof, definitely, various modifications and combinations may be made to them without departing from the spirit and scope of this application. Correspondingly, the specification and accompanying drawings are merely example description of this application defined by the appended claims, and is considered as any of or all modifications, variations, combinations or equivalents that cover the scope of this application. Obviously, a person skilled in the art can make various modifications and variations to this application without departing from the spirit and scope of this application. This application is intended to cover these modifications and variations of this application provided that they fall within the scope of protection defined by the following claims and their equivalent technologies.

[Explanation of symbols]

| | | | |
|---|---|---|---|
| 100: | motor control driver | 200: | Motor drive control |
| 300: | capacitor power bank | 310: | capacitor module |
| 320: | charging power supply | 321: | overvoltage protection |
| 322: | Capacitor DC/DC convertor | 400: | Central Controller |
| 410: | charge controller | 420: | first sensor |
| 430: | second sensor | 500: | dashboard |
| 510: | communication and monitor | | |

What is claimed is:

1. A capacitor power bank system with charging function of electric vehicle, comprising:
a Brushless Direct Current (BLDC) motor or an induction motor for receiving a first power from a capacitor power bank 300 to drive the electric vehicle and supplies second power generated through regenerative braking to the capacitor module 310 of the power bank 300 when the brake is operated;
a motor control driver 100 connected to the motor;
a motor drive control inverter 200 that adjusts and controls a rotation of the motor to drive with a predetermined revolution of revolutions (RPM);
a capacitor power bank 300 having a capacitor charging power system 320 that performs a charging, discharging, and protection function of the capacitor module 310 when an abnormality of the motor or inverter occurs during power supply to the motor controlling driver 100, and manages the abnormality of the cell in the capacitor module 310;
a charging controller 410 configured to control charging of the capacitor module 310;
a first sensor 420 configured to sense an overvoltage and the transient current of the motor controlling driver 100;
a second sensor 430 configured to sense a reverse current;
a central controller 400 for controlling the COPS 320 and the motor drive control inverter 200;
a dashboard 500 connected to the central controller 400, and having a communication and monitor 510 that provides a charge and discharge state of the power bank 300, a supply voltage state, and an abnormality in the voltage and temperature for each cell to the driver.

2. The capacitor power bank system for the electric vehicle of claim 1, wherein the motor driving control inverter 200 adjusts a frequency of a Brushless Direct Current (BLDC) motor or an induction motor connected to the motor controlling driver 100.

3. The capacitor power bank system for the electric vehicle of claim 1, wherein when the forward current is sensed from the first sensor 420, the motor drive control inverter 200 receives a command from the central controller 400 to adjust and control the frequency of the motor, and then drives the motor controlling driver 100.

4. The capacitor power bank system for the electric vehicle of claim 1, wherein the motor driving control inverter 200, when a proportional-integral-differential controller (PID) signal for adjusting and controlling a frequency of the motor with a voltage generated according to a resistor connected to the driver's accelerator pedal is transmitted to the motor driving control inverter 200, drives at a predetermined RPM by a supplied voltage or a supplied current.

5. The capacitor power bank system for the electric vehicle of claim 1, wherein the capacitor power bank is configured to have 1 or 2-3 banks in series, parallel, or serial/parallel, thereby easily replacing through a connector and a connection jack.

6. The capacitor power bank for electric vehicle of claim 1, wherein the capacitor power bank 300 has a built-in DC/DC converter 322 that supports a rapid charging and a discharge function during high current driving.

7. The capacitor power bank for electric vehicle of claim 1, wherein the capacitor charging power supply device (COPS) 320 maintains a balance of cells in the capacitor module 310 according to a command of the central controller 400, thereby charging is performed.

8. The capacitor power bank for electric vehicle of claim 1, wherein the capacitor charging power supply device 320 further comprises a transient voltage protection circuit 321 having a cut off circuit,
when a reverse current is sensed through the second sensor 430 by regenerative braking in the motor controlling driver 100, wherein the transient voltage protection circuit determines whether to charge the capacitor module or cuts off a voltage when a transient voltage occurs electric powered vehicle.

9. The capacitor power bank for electric vehicle of claim 1, wherein, the central controller 400, when a transient current, i.e., an over-current, is detected in the motor of the motor controlling driver 100 from the first sensor 420, to protect a user and/or the motor control driver 100, may control an electronic relay, an Insulated Gate Bipolar Transistor (IGBT), a gate voltage of a Field Effect Transistor (FET), or a base voltage of a Transistor (TR) in the capacitor module 310, and thus, the motor connected to the motor drive driver 100 is controlled through the motor driving control inverter 200, thereby the motor can be safely stopped or controlled to enable a constant speed driving.

10. The capacitor power bank for electric vehicle of claim 1, wherein, the central controller 400 output a signal to the COPS 320 of the capacitor power bank 300 for charging each cell in the capacitor module 310 when a reverse electromotive force is generated by regenerative braking by the motor control driver 100 and a reverse current is detected by the second sensor 430, thereby any one of a gate voltage of an Insulated Gate Bipolar Transistor (IGBT), a gate voltage of a Field Effect Transistor (FET), or a base voltage of Transistor (TR) embedded in the COPS 320 in the capacitor power bank 300 is turned on to charge in each cell in the capacitor module 310.

11. The capacitor power bank for electric vehicle of claim 1, wherein the central controller 400 issues a command to the CCS 320 to block the charging voltage from being supplied to the capacitor power bank 300 when a full charging voltage arrives at the input end of the power bank 300.

12. The capacitor power bank for electric vehicle of claim 1, wherein the communication and monitor 510 includes a Bluetooth or a Controller Area Network (CAN) communication to provide a user with a state of charging and discharging of the capacitor module 310, a voltage state, and a voltage and temperature abnormality of the cell.

13. The capacitor power bank for electric vehicle of claim 1, communication and monitoring functions through the communication and monitor 510 are performed through a universal asynchronous receiver transmitter (UART), and a monitoring is performed at least any one of a voltage and current balance abnormality of the capacitor power bank 300, a temperature abnormality, and an abnormal charge and discharge state of the cell.
